(19) United States
(12) Patent Application Publication
(10) Pub. No.: US 2013/0064508 A1
(43) Pub. Date: Mar. 14, 2013

(54) OPTICAL NETWORK TERMINAL SYSTEM USING PHYSICAL SECURITY FEATURES

(71) Applicant: SEAN PATRICK KELLY, York, PA (US)

(72) Inventor: SEAN PATRICK KELLY, York, PA (US)

(73) Assignee: TYCO ELECTRONICS CORPORATION, BERWYN, PA (US)

(21) Appl. No.: 13/230,061

(22) Filed: Sep. 12, 2011

(51) Int. Cl. G02B 6/38

(52) U.S. Cl. 385/56; 385/75

(57) ABSTRACT

Methods and apparatus for incorporating physical barriers to unauthorized network access through an Optical Network Terminal (ONT). The output terminals of an ONT are equipped with connectors having physical features unique to the networks to which they correspond so that only persons having a cable with a matching complementary connector can connect a computer or other electronic device to the ONT output terminal corresponding to that network and not to the output terminal corresponding to any other network. The input terminal of an ONT may be equipped with similar technology.

### FIELD OF THE INVENTION

The invention pertains generally to connectors for use in telecommunication networks such as voice, data, or video networks. More particularly, the invention pertains to connector interfaces on the Optical Network Terminals in Passive Optical Networks.

### BACKGROUND OF THE INVENTION

It is sometimes the case that enterprise organizations, such as governments, hospitals, businesses, schools, operate multiple distinct communication networks for which it is necessary or desirable to restrict access to a subset of personnel, functions or applications (e.g., (1) a university with different networks for students, faculty, and administrators, respectively, (2) a government with different networks for government employees with different levels of security clearance, (3) a cable television company with different levels of cable television service), (4) a hospital with a nurse station network, IP television network, badge reader network, and paging network.

In certain enterprise environments, it is known to use an optical network terminal or ONT as an access point to a network. Typically, an ONT is a small box (e.g., 6″×6″×2″) that has an input terminal for accepting an optical cable connector through which it may be coupled to a network and a plurality of output terminals through which a plurality of computers or other devices may be coupled to the network. In a typical office environment, the input terminal of the ONT may be coupled to the network via an optical cable that may run to a wall outlet or a home run. A plurality of devices in the same room or a multi-room area in the vicinity of the ONT are coupled to the various output terminals through individual cables. The cables connecting the computer to the ONT may by optical cables or electrical cables depending on the type of ONT. Presently, most computers connect to ONTs via electrical cables, but that may change rapidly. The signals for a plurality of different networks may be carried on a single optical fiber in the network infrastructure. The ONT typically demultiplexes the different network signals received at the input terminal and may be programmed to supply the signals of one of the networks to its multiple output terminals or may be programmed to supply the signals of different ones of the networks to different ones of the output terminals. The output terminals and mating cables normally all have the same form of connector, e.g., RJ-45 connectors for electrical connections or LC optical connectors for optical connections.

The terms input and output as used herein are not intended to be directionally limiting, but are merely exemplary. Specifically, some optical networks permit two-way communication through a single cable between the various nodes of the network such that the terms input and output are somewhat arbitrary. Herein, those terms generally are used to refer to data travelling from a server side to a user terminal side through the network as the output direction and data travelling from a user terminal side to server side through the network as the input direction. However, the terms are merely exemplary.

In the absence of suitable security features, anyone with a computer (or other electronic device with network interface capabilities) and a standard cable with conventional connectors on each end can connect a computer to any output terminal of the ONT to gain access to any of the networks that the ONT is programmed to supply at any of its output terminals. This is an undesirable condition in any of the aforementioned environments in which it is desired to restrict access to certain of the networks to certain personnel.

Some restrictions may be achieved using software approaches, such as passwords. However, passwords can be compromised through carelessness, electronic theft, and other means.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention comprises methods and apparatus for incorporating a physical barrier to unauthorized network access through Optical Network Terminals. More specifically, the output terminals of an ONT may be provided with connectors (e.g., receptacles) having special physical features unique to the networks to which they correspond so that only persons having a cable with a matching connector (e.g., plug) having a complementary special physical feature can connect a computer (or other electronic device) to the ONT output terminal corresponding to that network. Other cables having different plug connectors with different special physical features corresponding to other networks cannot be connected to that output terminal, but only to an output terminal having a receptacle that has a special physical feature complementary to that plug connector. The pairs of mating connectors may be color-coded, i.e., the two connectors of a pair of mating connectors have the same color, which color is different from every other pair of mating connectors.

To this end, the present invention facilitates discriminating mating among similar, but different, plugs and receptacles by using a system of geometrically matched connector components that allows certain combinations of plugs and receptacles—i.e., mating pairs—to mate, while preventing other combinations from mating.

Thus, different personnel with rights to access different networks are provided cables with different end connectors corresponding to the network to which they are allowed access. One end of the cable may be provided with a conventional connector for coupling to the computer and the other end, for coupling to the ONT, bears a connector having a special physical feature that is complementary to a physical feature of the output connector of the ONT to which that person is permitted access and which prevents that connector from being coupled to any other of the output connectors on the ONT corresponding to different networks (and thus having different, i.e., non-matching and non-complementary, special physical features).

Further, the input terminal of an ONT also may be equipped with a connector that has a special physical feature that distinguishes it from other connectors so that it may be connected to a wall outlet, for instance, only via a cable having a connector at one end having a special physical feature that is complementary to the physical feature of the input terminal of the ONT. Even further, the connector on the opposite end of the cable for coupling the ONT to the wall and the corresponding connector in the wall may similarly use special physical features.

In one embodiment, the network comprises: (a) a set of plugs having a housing having a front and a back orientation and having a front face defining an opening, the housing defining a first keying element on the front face around the opening, the keying element for each plug of the set of plugs being different; and (b) a set of receptacles, each receptacle having an opening to receive the plug, the opening defining a second keying element to cooperate with the first keying element, the second keying element for each receptacle of the set of optical receptacles being different and being adapted to cooperate with one and only one of the first keying elements, wherein plugs and receptacles having keying elements that cooperate are mating pairs.

### DESCRIPTION OF THE DRAWINGS

FIG. 1 shows a mating pair of the present invention in which a plug is being inserted into a receptacle.

FIG. 2 shows a non-mating pair in which a plug has a slot which is not in the proper position to accept a key of a receptacle.

FIG. 3 shows an end view of a plug showing a slot which accepts a key of a mating receptacle.

FIG. 4 shows an end view of a receptacle having a key which accepts a key of a plug of a mating pair.

FIG. 5 shows a plug having a slot configuration capable of mating with jacks having keys in different positions.

FIGS. 6(a)-6(c) show top perspective, front and rear views, respectively, of an MT-RJ connector plug having security features of the present invention.

FIGS. 7(a) and 7(b) show top perspective and front views, respectively, of an MT-RJ connector receptacle.

FIG. 8 shows a front and side perspective view of an LC connector plug having security features of the present invention.

FIG. 9 shows a front perspective view of an LC connector receptacle having security features of the present invention.

FIG. 10 shows schematically the discrete positions available for the first keying element.

FIG. 11 shows a series of LC connector plugs in which the first geometries are different.

FIG. 12 shows a hybrid duplex in which one duplex receptacle is a secure and the other is a standard, non-secure receptacle.

FIG. 13 is a plan view of the back panel of an Optical Network Terminal in accordance with one embodiment of the invention.

FIG. 14 is a plan view of the back panel of an Optical Network Terminal in accordance with another embodiment of the invention.

### DETAILED DESCRIPTION

ONT's are often used in enterprise communication networks (e.g., schools, governments, businesses) as access points to passive optical networks (PONs) and other networks. A passive optical network is a point-to-multipoint, fiber to the ONT network architecture in which unpowered optical splitters are used to enable a single optical fiber to serve multiple nodes. A PON consists of an optical line terminal (OLT) at the server side and a number of ONTs near end users. A PON configuration reduces the amount of fiber and server side equipment required compared to point to point architectures.

Downstream signals are broadcast to all end user nodes on a single fiber, which are demultiplexed by the ONTs and delivered to the individual computers, etc. coupled to the ONT's output terminals. Encryption or encoding is used to prevent eavesdropping. Upstream signals from the computers are combined onto the single fiber by the ONTs using a multiple access protocol, usually time division multiple access (TDMA).

An enterprise may use a PON to support a multiplicity of distinct networks, different subsets of which networks may be intended to be accessible to different subsets of the enterprise's personnel. For instance, in government, different networks may be accessible to different personnel with different levels of security clearance. As another example, a large business may have different networks dedicated to different aspects of its business (and therefore intended to be accessed only by the corresponding personnel working within those aspects). For instance, a business may support one secured network for accounting communications, data, and tasks, another, secured network for research and development communications, data, and tasks, and a third, relatively unsecured network for general business communications, data, and tasks.

An ONT typically is coupled to such an access point via a fiber optic cable. The input cable may be a standardized optical cable having standardized connectors at each end, such as LC plugs, while the wall outlet and the ONT input terminal bear LC receptacles. The ONT demultiplexer the data from the different networks and outputs the data from the different networks to different ones of its output terminals, to which individual computers may be coupled via cables. In the opposite direction, the ONT converts the signals from the individual computers from electrical signals to optical signals and multiplexes the signals onto the single fiber of the network infrastructure.

Most computer/ONT interfaces presently use electrical interfaces, as opposed to optical. Thus, the ONT may also convert the optical signals to electrical signals. In such cases, the computers couple to the ONT's via standard electrical cables bearing standardized electrical connectors, such as RJ-45 receptacle connectors at the output terminals of the ONT and input terminals of the computers and mating RJ-45 plugs at the ends of the cables.

In some cases, a given ONT may output the signals on a single network to all of its output terminals. For instance, an ONT that services only the accounting department would have no need to process the signals of any of the networks other than the accounting network. Therefore, that ONT may be designed or programmed to discard all of the data from all other networks besides the accounting network. In other cases, an ONT may be programmed to provide connectivity to a different one of the networks on the network cable to each of its output terminals. Alternately, it may provide connectivity to one network at two of its output terminals, connectivity to another network at a third output terminal, and discard the signals of all other networks. In yet another example, the ONT may be designed to permit or deny connectivity to different sets of networks at different ones of its output terminals. For example, a first output terminal may permit access to networks A, B, and C, while a second output terminal permits access only to networks A and C, and a third output terminal permits access only to network A. The possible permutations are essentially unlimited and will depend on various factors, such as the particular personnel that connect to the enterprise's network(s) via that particular ONT, the networks available from the network access point to which the ONT is coupled, and security considerations.

For enterprises with multiple networks, at least one of which requires restricted access, various security measures may be implemented to limit access to only authorized personnel (rather than anyone who has physical access to a network interface point, such as a wall outlet, output terminal of an ONT, a network switch, or any of the equipment in an network equipment rack or network equipment closet. One such measure is to require entry of a password to access the network.

Another measure is the use of a physical barrier to network access, such as cables with connectors having special physical features (e.g., keys) that permit mating of the cables only to network access points that bear a complementary special physical feature that complementarily matches that special physical feature and that prevent mating to network access points having different, non-matching complementary special physical features. Such a measure is most effective if the measure is employed end-to-end within the network or at least end-to-end in the portion of the network that may be physically accessible to personnel who do not have authority to access to all of the networks.

For instance, the use of a connector having one of the special physical features in a wall outlet so that only a cable with a complementary special physical feature that complementarily matches it can couple to it will be a less effective security measure if the opposite end of that cable is terminated with a standard connector, rather than another keyed connector. Specifically, let us consider a very simple example in which an enterprise operates two secured networks, the Green network and the Red network, and the wall outlets have receptacle connectors that are keyed so that some wall outlets have a receptacle connector with a first special physical feature corresponding to the Green network (a Green wall outlet) and some wall outlets have a receptacle connector with a second special physical feature corresponding to the Red network (a Red wall outlet). Furthermore, the enterprise has Green ONTS that are programmed to provide connectivity only to the Green network and are intended to be coupled to the network cable only through Green wall outlets and Red ONTs that are programmed to provide connectivity only to the Red network and are intended to be coupled to the network cable only through Red wall outlets. However, the input terminals of the ONTs comprise unkeyed receptacle connectors so that they can be mated to standard plug connectors. In such a case, an ONT capable of accessing only the Green network may be properly coupled to the wall outlet via a wall-to-ONT cable that has a Green connector on the wall side and a standard plug connector on the ONT side (e.g., a Green wall-to-ONT cable).

If an employee who had authority to access only the Green network illicitly obtained possession of a Red ONT, that employee could uncouple his or her Green ONT from the Green wall-to-ONT cable and couple the Red ONT to the ONT end of the Green wall-to-ONT cable and possibly gain unauthorized access to the Red network. However, if this enterprise also incorporated the special physical feature technology into the ONT side of the wall-to-ONT cables, then one could not simply plug a Red ONT into the ONT side of the Green wall-to-ONT cable because the connector at the ONT side of the Green wall-to-ONT cable would not mate with the input terminal of the Red ONT. In such a case, one would have to illicitly possess, not only the Red ONT, but also a cable having a Green plug at one end and a Red plug at the other end. However, the combination of special physical features deployed within the network for wall-to-ONT cables can be prearranged so that such a cable does not even exist. Such an arrangement could be as simple as designing the input terminals of the Green ONTs to have the same receptacle connector as the Green wall outlets so that Green ONTs couple to Green wall outlets through cables having two of the same keyed plug connectors (e.g., two Green plug connectors) at both ends and designing the input terminals of the Red ONTs to have the same receptacle connector as the Red wall outlets so that Red ONTs couple to Red wall outlets through cables having two of the same keyed plug connectors (e.g., Red connectors) at both ends. Thus, there would be no need for a cable with a Green connector at one end and a Red connector at the other end to even exist, thus making it substantially more difficult to gain illicit access to a network.

Yet further, the use of similar special physical feature technology at the output terminals of the ONT provides even greater security. For example, let us assume an enterprise uses ONTs that are programmed to interface with both the Red network and the Green network, e.g., it has four output terminals, two providing connectivity to the Green network and two providing connectivity to the Red network. If the output terminals are unkeyed, one could plug any standard cable into an empty one of the multiple unkeyed outlets of the ONT. In such a case, anyone with a computer and a standard cable can couple the computer to an unused output terminal of the ONT to gain access to either the Green or the Red network as long as he or she had access to that particular ONT. Thus, it is further advantageous to also incorporate the special physical feature technology into the output terminals of the ONTs (and the ONT-to-computer cables that couple to them).

In theory, even greater security can be achieved by incorporating the special physical feature technology into the computer side of the ONT-to-computer cables, but this would require incorporating the special connectors into the computers themselves, which may not be reasonably practical insofar as incorporating custom connectors into a computer may be prohibitively expensive and might substantially diminish the usability of the computer (e.g., a computer lacking a standard network connector could not couple onto a conventional network).

Another option to even further enhance security at the computer or other device interface is to use a cable with a keyed connector in accordance with the present invention at the ONT side and a locking connector at the computer side. For instance, TE Connectivity sells a locking connector that fits into a conventional connector, but can be locked into the conventional connector (using a key) so that it can only be removed from a conventional receptacle by someone who has the physical key to unlock the mated connectors. In this manner, an unauthorized person would not be even be able to release the conventional connector at the end of the cable that is coupled to the computer from the computer.

In accordance with the present invention, connectors with special physical features may be incorporated into the output terminals of the ONTs (and, consequently, complementary special physical features are incorporated into connectors at the ONT sides of the ONT-to-computer cables). There would be a first set of connectors for incorporation into the ONT output terminals, each with a different special physical feature, and a second set of complementary connectors for use on the ONT sides of the ONT-to-computer cables, each having a different complementary special physical feature. The first set of special physical features of the first set of connectors (e.g., the ONT output receptacle connectors) and the second set of complementary special physical features of the complementary connectors (e.g., the ONT-to-computer cable plug connectors) are selected such that each one of the special physical features of the first set permits coupling only to an opposing, complementary connector of the second set that bears the one particular complementary special physical feature that complementarily matches it. All other pairs of one of the special physical features of the first set and one of the complementary special physical features of the second set physically interfere so as to prevent coupling thereof. Thus, one cannot connect a cable to an output terminal of an ONT containing a special physical feature unless that cable has a connector with a special physical feature complementary to the special physical feature of the ONT output terminal.

For additional security, the special physical feature technology also may be implemented at the input terminals of the ONTs (and, consequently, also in the connectors at the ONT sides of the wall-to-ONT cables). That is, each different type of ONT (i.e., provides connectivity to a different subset of networks) has a different one of a set of input connectors, each of which can be coupled to only one of a set of complementary connectors (which are used on the ONT sides of the wall-to-ONT cables). If the special physical feature technology is also incorporated into the wall outlets (and, consequently, also in the connectors on the wall sides of the wall-to-ONT cables), it would even further enhance security because, theoretically, a cable would not even exist that could couple a Red ONT to a Green wall outlet, as discussed above.

To provide even greater security, the two sets of connectors used at the output terminals of the ONTs (e.g., the ONT output receptacle connectors and their complementary ONT-to-computer cable plug connectors) are a different set of connectors than are the two sets of connectors used at the input terminals of the ONTs and/or the wall outlets (e.g., the ONT input receptacle connectors and their complementary wall-to-ONT cable plug connectors). This would circumvent the possibility of bypassing the ONT entirely and directly connecting a computer programmed to execute the ONT's functions directly to the wall outlet.

In ONT's that output electrical signals at their output terminals, this will inherently be the case since the base form factor of the electrical connectors at the output terminals of the ONTs will be inherently incompatible with the base form factor of the optical connectors at the input terminals of the ONTs, regardless of the sets of special physical features incorporated into the various connectors. This also would be true of optical-to-optical ONTs if they used different base form factor connectors at their input and output terminals respectively, e.g. LC connectors at the input terminals and SC connectors at the output terminals. However, if the optical-to-optical ONTs use the same base form factor connectors at both their input terminals and output terminals, then, preferably, the sets of special physical features and complementary special physical features used at the output terminals of the ONTs and mating ONT-to-computer cables, respectively, should be different from the sets of special physical features and complementary special physical features that are used at the input terminals of the ONTs and/or wall outlets and mating wall-to-ONT cables, respectively.

Of course, it also may be advisable to additionally include the use of software security measures, such as passwords, for additional security in all cases.

The various connectors of the system of connectors as described hereinabove may be substantially identical and substantially in accordance with a conventional standardized connector form factor, such as the RJ-45 form factor electrical connectors commonly used in electrical cable network connectivity or the LC form factor optical connectors commonly used in optical cable network connectivity, but with the addition of the special physical feature technology discussed here.

The two sets of special physical features and complementary special physical features should be designed so as to also prevent connection between any of the connectors bearing any of the special features and an opposing connector lacking any special physical feature, e.g., a standard RJ-45 connector.

Turning now to the details of the actual connectors and the special physical features, FIG. 1 illustrates one embodiment of a mating plug 101 and receptacle 100 of a connector system in accordance with the principles of the present invention. As shown, the plug 101 is partially inserted into the receptacle 100, which, in this embodiment, is a jack having a tub portion 102. Although a jack is discussed herein in detail, it should be understood that the receptacle of the present invention is not restricted to a jack and may be any structure configured to receive a plug, including, for example, an adapter for connecting two plugs together or an integral connector on an active device (e.g., transceiver) or passive device (e.g., splitter).

The plug typically contains a conductive or optical element, such as a fiber or wire, which mates with a similar element in the receptacle. In fiber optic applications, it is common for the optical element to be contained in a ferrule, which in turn is housed by the plug. In a preferred embodiment, the ferrule is an MT-type ferrule.

The outer surface of the plug 101 and the inner surface of the tub 102 have first and second complementary geometries, respectively, which cooperate to allow only certain pairs of plugs and receptacles to mate (herein “mating pairs,” “mating plug and jack,” or “keyed pair”), and which physically interfere for all other combinations of plugs and jacks (herein “non-mating pairs,” “non-mating plugs and jacks” or “non-keyed pairs”), thereby preventing non-mating plugs and jacks from effecting an optical or electrical coupling.

The first and second geometries may embody any known keying mechanism which discriminates between connector components. Such keying mechanisms include, for example, a key and slot relationship between the plug and jack, a receptacle dimensioned to receive only certain sized or shaped plugs, and even a magnetic signature for either attracting (for mating pairs) and repulsing (non-mating pairs). Preferably, the keying mechanism involves just a slight modification to the plug and jack such that essentially the same molds can be used to manufacture connectors of different keyed pairs. Although molding is preferred, it is should be understood that other techniques for producing the first and second geometries can be used including, for example, over molding and machining.

In one embodiment, the invention uses a key and slot mechanism. For simplicity, the term “keying elements” refers collectively to the key and the slot. Specifically, the slot can be embodied in the first or second geometry and the key can be embodied in the other geometry. In the particular embodiment shown in FIGS. 1-4, the key is part of the second geometry, while the slot is part of the first geometry; that is, the plug 101 has a slot 103 and the tub portion 102 of the jack has a key 104.

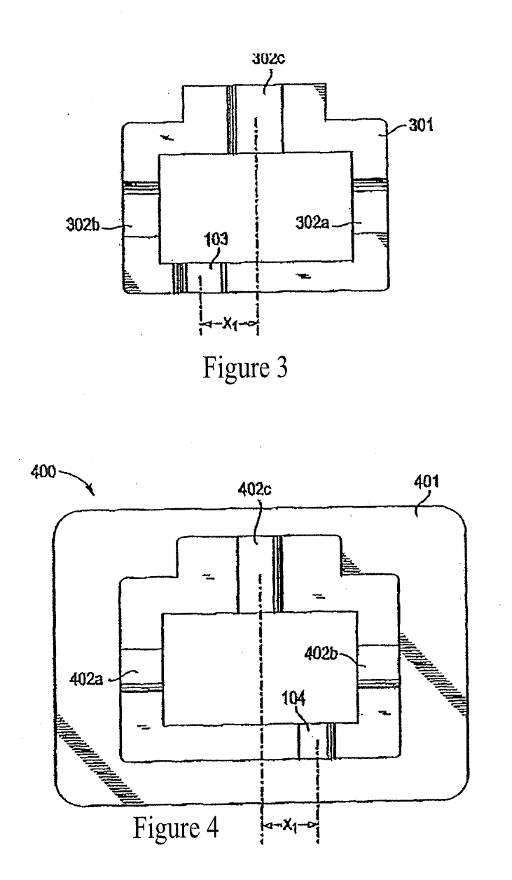

This configuration is preferred since the key may cooperate with other “ribs” on the connector for pre-alignment purposes. More specifically, with particular reference to FIG. 3, an end view of housing 301 of the plug 101 is shown. The housing comprises four walls each wall having a slot 103, 302a, 302b, and 302c, respectively. FIG. 4 depicts an end view of housing 401 of the tub 400 in which the key 104 and ribs 402a, 402b, and 402c are disposed on the walls of the housing. The key 104 and the ribs 402a, 402b, and 402c cooperate with the slots 103, 302, 302a, 302b, and 302c, respectively, to effect pre-alignment of the ferrule located within the plug with the jack before final mating of the connector plug with the connector jack. The final mating may be between the conductive elements of the connector system, such as, for example, between a couple of MT-type ferrules, which employ precise alignment pins/receiving holes on the ferrule face. Such ferrules are well known in the art. By pre-aligning the MT ferrules through the synergistic use of the key and slot, the inter-engagement of the closely-toleranced alignment pins/receiving holes is facilitated. The above-described synergistic keying and aligning feature of the present invention is realized with the MT-RJ connector (Tyco Electronics, Harrisburg, Pa.).

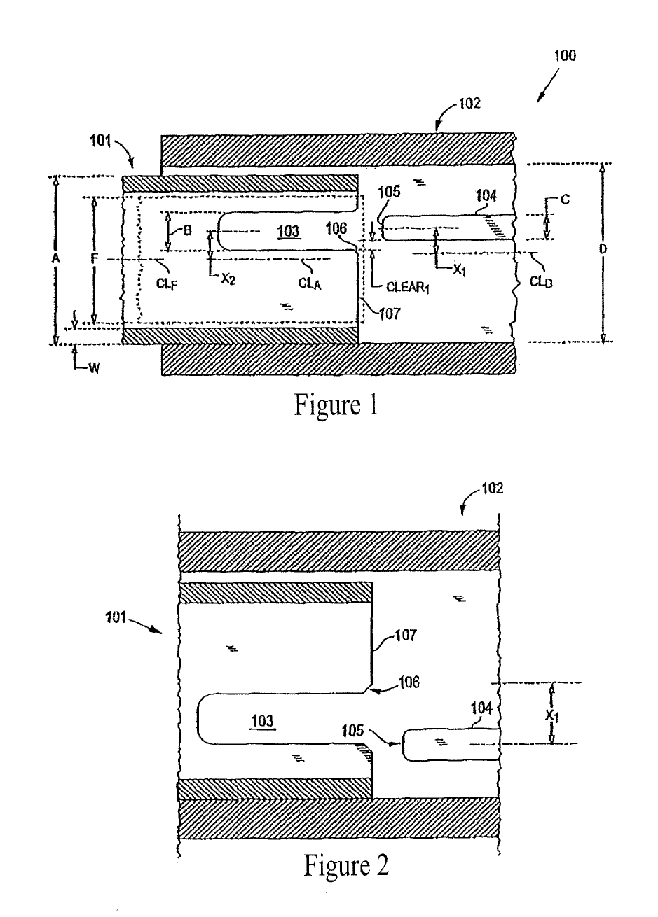

In a preferred embodiment, the mating end of the key 104 contains a flat portion shown as 105 and the mating end of the plug 101 has chamfers 106 on the corners of the edges of the slot 103, while the remainder of the mating end of the plug comprises a flat portion 107. The radius corners on the key 106 and the chamfers on the plug 107 work as a guiding device and provide for the necessary alignment between the key and the slot when the plug is inserted into the tub of the jack. On the other hand, as shown in FIG. 2, when a user attempts to mate two non-mating plug and jack components, the flat portion of the key 105 contacts the flat portion of the plug 107 and provides for definite physical interference between the plug and jack when the slot and key do not correspond. Accordingly, the use of this geometry prevents a user from forcing two non-mating plugs and jacks together. Therefore, the physical interference provided between the flat portion 105 of the tub and the flat portion 107 of the key assures that only desired combinations of plugs and jacks will mate.

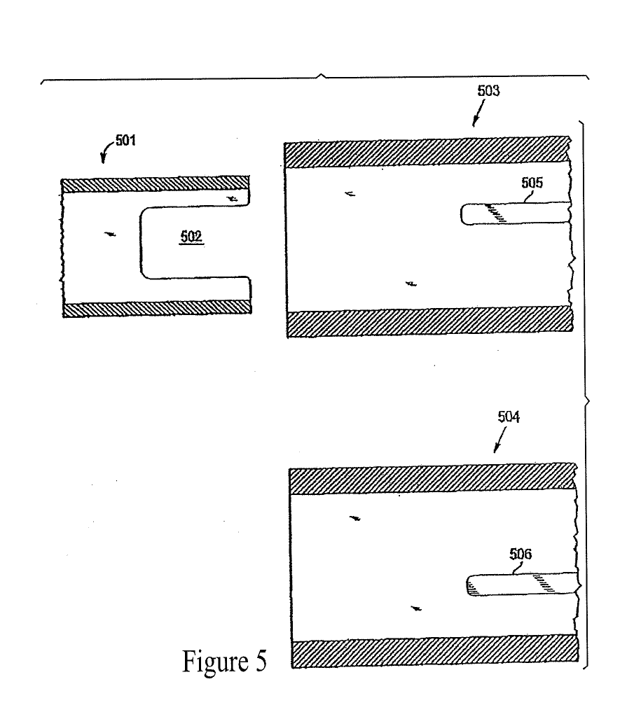

The position of the key 104 on the tub 102 and the slot 103 on the plug 101 can be varied in such a manner so that a plurality of mutually-exclusive slot and key positions are formed. In one embodiment, the series of key and slot locations are mutually exclusive so that there is a one-to-one correspondence between jacks and plugs. In another embodiment, certain plugs may be configured to mate with a variety of different jacks. For example, it may be worthwhile to give network administrators or people with high security clearance certain “master” plugs which are capable of mating with a number of jacks having different slot positions. Referring to the figures, FIG. 5 shows an embodiment of a master plug 501 which has a slot 502 that is configured (which, in this embodiment, means it is wide enough) to mate with jacks 503 and 504 which have different key positions 505 and 506, respectively. Although a wide slot is used in this embodiment to effect mating with two or more jacks having different key configurations, it should be understood that other embodiments are possible, such as, for example a plug with two or more slots.

The number of possible mutually exclusive mating pairs for a given plug and receptacle is a function of the physical parameters of the plug and the receptacle. More specifically, with reference to FIGS. 1-4, mutual exclusivity is ensured by adhering to the following relationships:

X1−C/2+(D−A)+Δ<=F/2 (1)

X2+B/2<A/2−W (2)

X1a+Clear1+Z=X1b (3)
wherein:
A=the width of the plug 101;
B=the width of the slot 103 on the plug 101;
C=the width of the key 104;
D=the distance across the opening of the tub;
F=the width of the ferrule residing within the plug;
Δ=CLF−CLA, wherein
   CLA=centerline of the width of the plug; and
   CLF=centerline of the ferrule residing within the plug.
X1=the distance from the center of the opening in the tub 102 to the center of the
key 104 for each mutually exclusive position.
X2=the distance from the center of the plug 101 to the center of the slot 103 for each
mutually exclusive position;
X1a=the X1 distance for a sequentially first key in a series of connectors;
X1b=the X1 distance for a sequentially second key in a series of connectors;
W=the wall thickness of the plug housing;
Z=the minimum distance required to ensure that the flat portion of the key does not contact the flat portion of the plug 107 when a user attempts to mate a mating pair; and
Clear1=the clearance distance between the center side of the key and the center side of the slot.

These relationships must be satisfied for the mating pairs to mate and for the non-mating pairs to definitely not mate. Specifically, for a mating pair, Relationship (1) requires that half the ferrule width must be no less than X1 less one half of C added to the difference between the width of the tub opening D less the width of the plug added to the difference between the centerline of the ferrule within the plug and the centerline of the plug. This ensures that the key is not positioned outside of the area on which at least a portion of the ferrule will reside. By adhering to this parameter, the key will have some overlap with the ferrule, and thus will provide for pre-alignment of the ferrule in the same manner as do the ribs on the three sides of the ferrule without the key.

Relationship (2) requires that X2 added to one-half of dimension B is less than one-half of dimension A less W. This assures that the slot resides on the plug within the confines of the plug walls.

Finally, according to Relationship (3), for each mutually exclusive position, the distance X1 for the first connector in the system (X1a) added to Clear1 added to a predefined interference interval Z would correspond to the distance X1 for the next slot/key position (X1b). Z is the minimum distance required to ensure that the flat portion of the key does not contact the flat portion of the plug 107 when a user attempts to mate the two portions of a connector which is intended to mate.

By way of example, four mutually exclusive locations for locating the slot on the plug housing and the key on the tub are defined below for an MT-RJ connector. The MT-RJ connector has the following dimensions:
A=7.150.05 mm
B=1.25 mm
C=0.950.04 mm
D=7.24.+−.0.04 mm
F=4.50.04 mm
Clear1=0.15 mm
W=0.8 mm

Based on these MT-RJ dimensions, it has been found that the following X1 key positions satisfy the relationships above:

| Mating pair | Key Position | X1 |
|---|---|---|
| 1 | 1 | 0.8 mm |
| 2 | 2 | 1.6 mm |
| 3 | 3 | 0.8 mm |
| 4 | 4 | 1.6 mm |

Although the data above indicates four mutually exclusive positions, it should be understood that additional positions are possible within the parameters of the MT-RJ connector. Additionally, it should be understood that the combinations of various key positions can be used to increase the number of permutations of mating pairs. For example, in addition to the four mating pairs listed above, additional mating pair configurations may obtained from the following combinations of key positions:

| Mating pair | Key Positions |
|---|---|
| 5 | 1, 2 |
| 6 | 1, 2, 3 |
| 7 | 1, 2, 3, 4 |
| 8 | 2, 3 |
| 9 | 2, 4 |
| 10 | 2, 3, 4 |
| 11 | 3, 4 |
| 12 | 1, 3 |
| 13 | 1, 4 |
| 14 | 1, 3 |
| 15 | 1, 2, 4 |

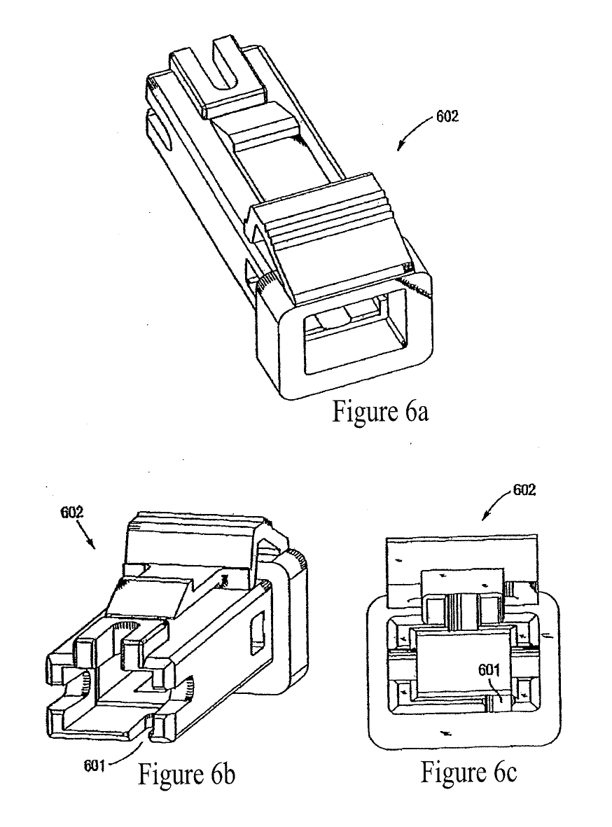

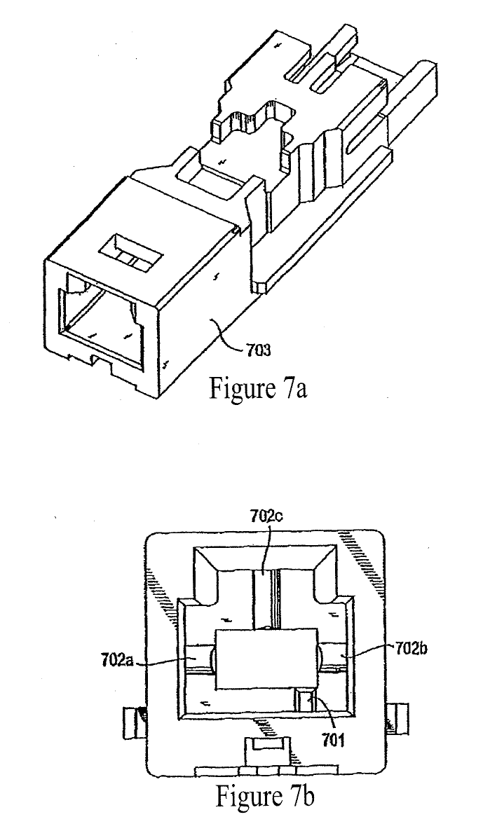

In one embodiment, the key and slot components are combined with the industry standard MT-RJ connector. FIG. 6 and FIG. 7 show the key-slot combination added to the MT-RJ connector as produced by Tyco Electronics of Harrisburg, Pa.

FIGS. 6(a)-(c) show the plug 602 of the MT-RJ connector combined with the slot 601 of the present invention. FIGS. 7(a) and 7(b) show the center tub portion 703 of an MT-RJ connector jack. The key is shown as 701 located in one of the plurality of possible positions. The three pre-alignment ribs are shown as 702a, 702b, and 702c. The key 701 functions as the discriminating member for allowing or preventing mating with a plurality of plugs, while at the same time functioning as the pre-alignment member for the remaining side of the ferrule not aligned with ribs 702a, 702b, and 702c.

To provide to the user a simple and readily apparent indication of which plugs mate with which receptacles, it is preferable to mark mating pairs with indicia or color to indicate their compatibility. In a preferred embodiment, the components of a mating pair (e.g., the plug and receptacle) are the same color, which color is different than all others used in the connector system.

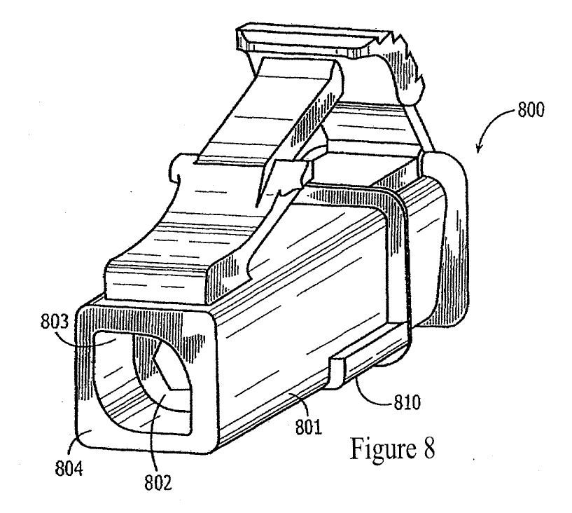

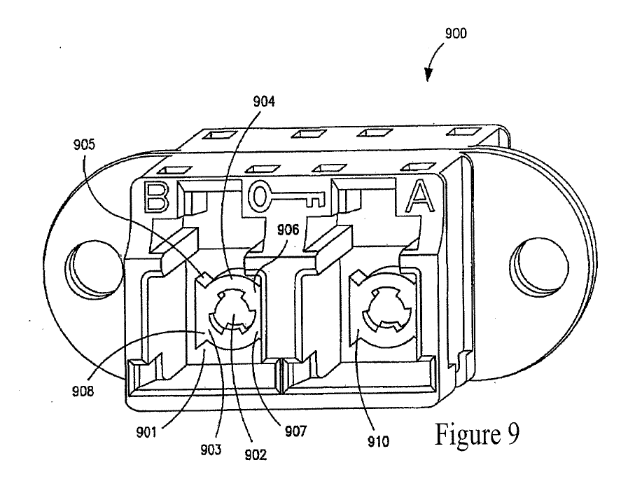

Referring to FIGS. 8 and 9, another embodiment of the connector system of the present invention is shown in connection with LC type connectors. FIG. 8 shows a plug 800, which is one of a set of different plugs in the system. Each plug has a housing 801 which defines a first geometry. The first geometry comprises a front face 804 with an opening 802, and a ferrule (not shown) within the housing and disposed in the opening. Around the opening 802 is a first keying element 803. The keying element for each different optical plug of said set of optical plugs is different.

FIG. 9 shows a receptacle 900 for receiving a particular plug (not shown) and is one of a set of different receptacles. The receptacle 900 has a second geometry configured to receive the first geometry of a plug. The second geometry comprises a cavity 901 to receive a plug and a ferrule-receiving portion 904 having a borehole 902 to receive the ferrule of the plug. The ferrule-receiving portion 904 defines a second keying element 903 to cooperate with a first keying element of a particular plug. The second keying element for each receptacle of said set of said optical receptacles is different and is adapted to cooperate with one and only one first keying element. Plugs and receptacles having keying elements that cooperate are referred to herein as “mating pairs”.

Although the LC connector system described above is a single-fiber ferrule rather than a multifiber ferrule, the general keying features are essentially the same as those described above with respect to the MT-RJ connector. Further, the keying features of the plug 800 and receptacle 900 of the present invention may be implemented in any well known optical connector including, for example, other single-fiber ferrule connectors such as MU, SC, ST, or FC connectors. For illustrative purposes, the security features are described with respect to the LC connector system, which includes the LC plug (plug 800) and LC adapter (receptacle 900). Aside from the security features described herein, these connector components are the same as those specified in the LC Standard available on-line or from OFS (Japan), and the common features between them will not be addressed herein.

Like the MT-RJ embodiment described above, the keying features of the LC connector are contained on the front face of the plug. This is important for a number of reasons. First, these features can be molded with a relatively small change to the mold dies. Specifically, the opening around the ferrule is typically defined in the molding process by a core pin which is inserted into the outer mold. Changing core pin configurations is a relatively inexpensive and easy step compared to altering the configuration of the outer molds. Therefore, as mentioned above, the connector system of the present invention provides for a variety of different plug configurations with only slight modifications to the molding process.

Having the security features on the front face of the plug also provides for an early indication of non-mateability. Specifically, since the features are located on essentially the leading edge of the plug, they are positioned optimally to “stub” as soon as possible when a plug is inserted into a non-mating receptacle. Interference between connector components which are non-mating should be made as soon as possible to minimize the possibility of coupling light between connectors. That is, if close enough, optical connectors are able to couple, albeit with high loss, even if the connectors are not mechanically engaged. This condition can be meliorated by preventing the light carrying elements from getting too close—hence the desire to stub early. Stubbing early also provides an early signal to the user that the plug is non-mating and avoids the tendency of trying to force a plug into a non-mating receptacle.

Additionally, by locating the keying feature on the leading surface of the plug, the corresponding keying feature on the receptacle may be located internally and still provide an early indication of non-mateability. This is beneficial since it is desirable to locate the keying feature of the receptacle internally to minimize the ability of the keying feature to be tampered with or otherwise overridden. As discussed below, this is of particular importance in the configuration of the MT-RJ and LC connectors in which the plug defines the slot and the receptacle defines the key. If the key is removed, the security feature is breached. Having the key located within the receptacle reduces this risk.

Yet another benefit of having the keying features located on the front face of the plug is the visual indication the plug provides with respect to its keying features. That is, one can readily determine the keying configuration of the plug by visual inspection of its front face.

There is no need to look into an opening to inspect the internal geometry of the plug to determine its keying configuration.

Another aspect of the present invention is an economical process for producing the plugs by altering their geometry at their front end though a simple mold modification. In a preferred embodiment, the process comprises: (a) molding a first housing for a first plug of a set of plugs using a core pin to define an opening having a first keying element in a first position; and (b) molding a second housing for a second plug of the set of plugs by adjusting only the core pin to define the opening having a first keying element in a second position different than the first position.

The keying elements that may be used in the LC connector are the same as those described above with respect to the MT-RJ embodiment. In a preferred embodiment, the keying elements comprise a slot and a key. The slot can be embodied in the first or second geometry and the key can be embodied in the other geometry. In a first configuration, the slot is embodied in the first geometry and the key is embodied in the second geometry, while in a second configuration, the key is embodied in the first geometry and the slot is embodied in the second geometry.

The LC connector shown in FIGS. 8 and 9 has a first configuration. This configuration is advantageous for a number of reasons. First, the first keying features do not prevent a plug from mating with an ordinary receptacle. This is particularly beneficial since a plug with keying elements can be nevertheless “mated” with standard equipment used for the polishing, testing, and inspection of the ferrule. Specifically, the polishing, testing, and inspection equipment for single fiber ferrules typically comprises a ferrule receiving interface, similar to that of a receptacle, which receives just the ferrule disposed in the opening of the housing. The housing is not engaged. If a key protrudes into the space between the opening and the ferrule, it would preclude coupling with this existing equipment. Conversely, by having slots extend radially outward from the opening, and thereby maintain the space between the opening and the ferrule, a standard ferrule receiving interface, which does not have keying features, can be used. For example, a plug having a first keying element can be coupled to a standard LC ferrule receiving interface connected to a polishing device for polishing the ferrule, or to a microscope for inspecting the endface geometry of the ferrule, or to a photodetector for testing optical attenuation of the ferrule assembly.

Furthermore, since the physical “barrier”—i.e., the key—is located on the receptacle in the first configuration, it will serve to facilitate discriminatory mating among, not only plugs employing security features, but also existing plugs which have no security features of the present invention. Specifically, if a slot in the plug is necessary to accommodate the key of the receptacle, then plugs without slots will not mate with receptacles having the key. Therefore, ordinary, non-secure type plugs which do not have the slot in the proper position will not mate with the receptacle. In contrast, a non-secure receptacle will mate with a secure plug of the first configuration. Specifically, since the physical barrier is absent from the receptacle, any ordinary or secure plug can mate with it. As discussed below, the situation with the second configuration is opposite from that of the first, meaning that a secure plug cannot mate with a non-secure receptacle, but a secure receptacle can mate with a non-secure plug. To provide for discrimination between secure and non-secure connectors components, a secondary key is added to the system as discussed below.

A connector system having the second configuration offers certain benefits, but also presents certain challenges. One benefit is that the space consuming security feature—i.e., the slot—resides in the receptacle which is typically larger than the plug and better suited for accommodating this feature. That is, since a slot is defined by the material around it, a slot requires more room than a key. The receptacle does not have the same space constraints as a plug (which is designed to be inserted in the receptacle) and may be more capable of accommodating the slot than the plug. Additionally, it may be preferable to have one “master” plug which plugs into all receptacles having security features. This is easily accomplished with a connector system of the second configuration. Specifically, the master plug would simply be one having no key to interfere with the first geometry of the receptacle. The simplicity in offering a master plug in the connector system of the second configuration also gives rise to a challenge facing the system—the ability of non-secure plugs to mate with secure receptacles (discussed below).

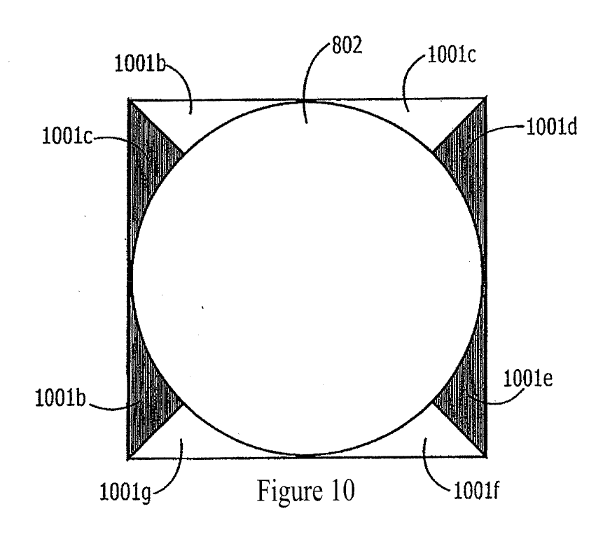

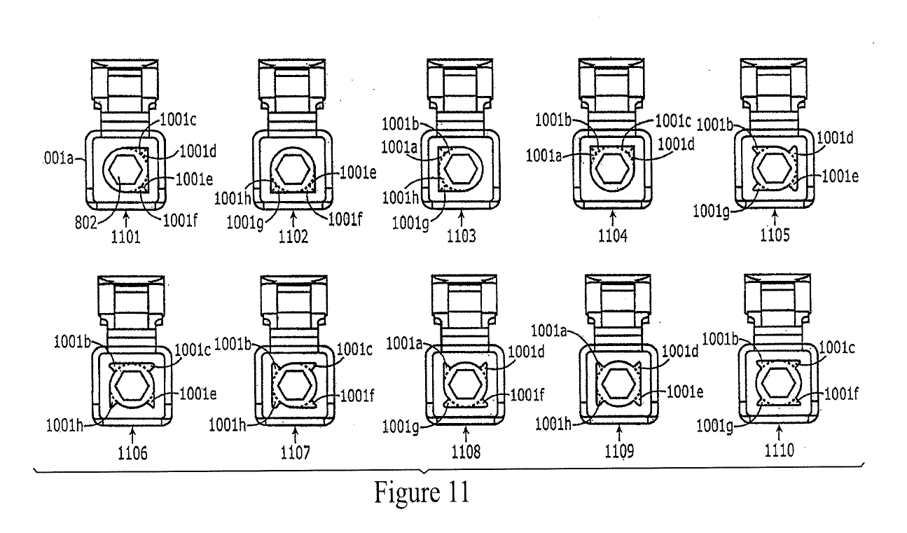

Referring to FIG. 10, a preferred embodiment of the first keying element 803 is shown schematically. The figure shows the opening 802 in which the ferrule is disposed and which is configured to receive the ferrule-receiving portion 904. Positioned around the opening 802 are spatially discrete positions 101(a-(h) for the first keying element. Similar discrete positions exist around the ferrule-receiving portion 904 (see FIG. 9) to define the location of the second keying element. In a preferred embodiment, the first keying element comprises one or more slots in a combination of positions 101(a-(h) and the second keying element comprises keys in corresponding positions. It should be understood that to facilitate cooperation between the first and second keying elements, the combination of slot positions in the plug must be the same as the combination of key positions in the ferrule receiving portion 904. In other words, each slot must correspond to a key in the same relative position to facilitate a mating pair. For example, a plug having a first keying element which comprises slots in positions 1001a, 1001d, 1001e, and 1001d, will mate with a receptacle having a second keying element comprising keys 905, 906, 907, and 908 is the same relative positions (see FIG. 9).

The number of slots in the combination of first keying elements depends upon the number of possible positions of the slots. Specifically, the number of possible permeations of different mating pairs is given by the following equation:

$${}_{n}^{}{C}{}_{r}^{} = \frac{n !}{r ! ( n - r ) !}$$

wherein:
n equals the number of spatially discrete positions for the keying elements, and
r is the number of positions occupied.
Thus, ₙCᵣ provides for the number of mutually exclusive combinations or permeations of mating pairs.

Below is a table providing data on the theoretical number of mating pairs, .sub.nC.sub.r, for different n and r values.

| Number of Spatially Discrete | Number of Positions | Number of Mutually |
|---|---|---|
| Positions | Occupied | Exclusive Positions |
| 4 | 1 | 4 |
| | 2 | 6 |
| | 3 | 4 |
| | 4 | 1 |
| 5 | 1 | 5 |
| | 2 | 10 |
| | 3 | 10 |
| | 4 | 5 |
| | 5 | 1 |
| 6 | 1 | 6 |
| | 2 | 15 |
| | 3 | 20 |
| | 4 | 15 |
| | 5 | 6 |
| | 6 | 1 |

From this data, it is clear that the maximum number of permutations (i.e., ₙCᵣ) is reached when the number of positions occupied equals n divided by 2. Therefore, in the preferred embodiment, either n/2 slots (if n is an even integer) or (n.+−.1)/2 slots (if n is an odd integer) of spatially discrete positions are occupied by either a slot with respect to the plug or a key with respect to the receptacle. (For purposes of simplicity, hereinafter, n will be presumed to be an even number.) Therefore, using the equation above, the embodiment shown in FIGS. 8, 9 and 10, in which n equals 8 and r equals 4, the maximum number of permutations of mating pairs is 70.

Referring to FIG. 11, different of plugs 1101-1110 of a set are shown in which the first keying elements comprise slots in different combinations of positions as defined in FIG. 10 and accompanying text. In these drawings, the opening 802 which is constant in all the plugs and the slot positions are shown with a phantom line. Specifically, plug 1101 shows slots in a combination of positions 1001c, 1001d, 1001e, and 1001f, plug 1102 shows slots in a combination of positions 1001e, 1001f, 1001g, and 1001h; plug 1103 shows slots in a combination of positions 1001a, 1001b, 1001g, and 1001h; plug 1104 shows slots in a combination of positions 1001a, 1001b, 1001c, and 1001d; plug 1105 shows slots in a combination of positions 1001b, 1001d, 1001e, and 1001g; plug 1106 shows slots in a combination of positions 1001b, 1001c, 1001e, and 1001h; plug 1107 shows slots in a combination of positions 1001a, 1001c, 1001f, and 1001h; plug 1108 shows slots in a combination of positions 1001a, 1001d, 1001f, and 1001g; plug 1109 shows slots in a combination of positions 1001a, 1001d, 1001e, and 1001h; and plug 1110 shows slots in a combination of positions 1001b, 1001c, 1001f, and 1001g. It should be understood that each of the plugs described above will mate with a receptacle having a key in the same position. For example, plug 1109 will mate with receptacle 900 which has keys 904, 905, 906, and 907 in the same positions as the slots (i.e., 1001a, 1001d, 1001e, and 1001h).

In a preferred embodiment, the connector system of the present invention may contain one or more master plugs of varying levels. That is, there may be lower-level master plugs, which can mate with receptacles of two different networks, or higher-level master plugs, which can mate with receptacles of three or more networks. The difference in the level of the mater plug is a function of the r number of slots occupying n possible positions—the more slots there are, the higher the plug's level. Specifically, the master plug comprises a first keying element having a third combination of greater than n/2 slots, in which the slots occupy the positions of at least two different first combinations as described above. Higher level master plugs have slots which occupy the positions of three or more different first combinations.

Aside from showing the different combinations of keying elements, FIG. 11 illustrates the ease with which the various plugs can be made. Specifically, in a preferred embodiment, the process of manufacturing an optical connector comprises molding different plugs by adjusting the core pin which defines the opening 802 while leaving the outer molds essentially the same. In other words, rather than using different molds to modify the outside of the housing—which can be expensive, the present invention involves simply adjusting the core pin—which is relatively inexpensive. Referring to FIG. 11, the process is described in greater detail. The process comprises first molding a first housing 1101a for a first plug 1101 of a set of plugs 1101-1110 using a core pin (not shown) to define an opening 802 and a first keying element in a first combination of positions 1001c, 1001d, 1001e, and 1001f. Next, a second housing 1102a for a second plug 1102 is molded by adjusting only said core pin to define first keying element in a second combination of positions 1001e, 1101f, 1001g, and 1101h, which is different from first combination of positions.

To effect the different combinations of positions, the core pin is preferably adjusted by rotating it in θ increments, in which θ is equal to 360°/m, wherein m is an integer. Preferably m is an integer from 2-18, more preferably from 2-5, and even more preferably from 3-4. In the embodiment shown in FIG. 10, m is 4, thus the core pin is adjusted by rotating it in 90° increments. It should be clear that rotating this core pin in 90° increments in subsequent molding operations will produce plugs 1103 and 1104, respectively. Plugs 1105-1108 were prepared using a different core pin which was also rotated in 90° increments. Plugs 1109 and 1110 were prepared using yet a different core pin which was rotated in a 90° increment. It is worthwhile to mention that since the combination of positions 1001b, 1001c, 1001f, and 1001g is symmetrical with respect to two axes, the core pin can only be rotated by one 90° increment before repeating the same combination of positions.

Once the housings are prepared, a ferrule is disposed in the opening of each housing to form a subassembly. A fiber may be terminated in the ferrule either before or after the preparation of the subassembly. For field-terminatable connectors, it may be preferable to dispose just a fiber stub in the ferrule. This configuration facilitates field installation of a fiber as discussed, for example, in WO2005004285. Regardless of whether a stub or a fiber is terminated in the ferrule, the preferred keying arrangement of the present invention in which slots radiate outwardly from the opening 802 allows the subassembly of the LC connector to be polished, inspected, and tested using standard polishing equipment as mentioned above.

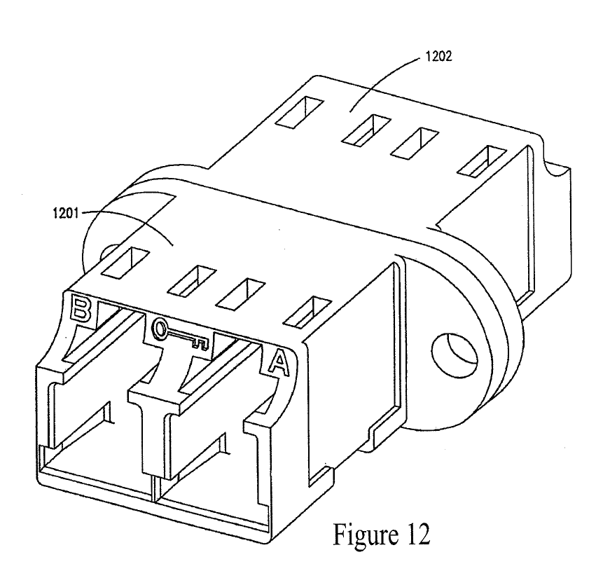

An advantage of the connector system of the present invention is that different receptacles may be combined to form “hybrid” adapters. More specifically, aside from the second keying element extending outward from the ferrule receiving portion, the receptacles are the same as those used for standard connectors. This allows different receptacles to be combined back to back to form hybrid adapters. For example, referring to FIG. 12, a particularly preferred embodiment is shown in which, a secure receptacle 1201 is combined with a nonsecure receptacle 1202 by ultrasonically welding, or other known technique. Such a configuration is particularly useful in situations in which the nonsecure end of the adapter is located in an inherently secure area, for example, behind a wall or panel, where access is already limited. In other words, since connectors within cabinets and walls cannot be accessed readily after construction, the advantages derived from a secure connector at those ends would be minimal. Thus, it is preferable to use a nonsecure connector in these situations so the installer need not concern himself with the “proper” secure connector configuration during the installation of the infrastructure wiring.

To discriminate between secure and non-secure connector systems, the present invention provides for a secondary key & slot configuration, which is either non-existent or in a different position for all plugs and receptacles which are outside of the given connector system 800. For example, referring to FIG. 8, the first geometry comprises a secondary plug 810, which is shown in the same relative position for all plugs of a given set, but which may be in different positions as discussed below. Referring to FIG. 9, the second geometry of the geometry of the receptacle comprises a secondary slot 910 are preferably, but not necessarily, in the same position for all the receptacles of a given set of receptacles. The secondary slots 910 are adapted to receive secondary keys 810. This way, only plugs and receptacles of a given set of having accommodating secondary keys/slots will mate. In a preferred embodiment, at least a portion of the secondary key 810 is disposed in the plug and is an extension of the side loading structure which is an LC connector standard. Therefore, in the preferred embodiment, the secondary key not only provides for discriminating mating between secure and non-secure connectors, but also enhances side load strength.

It is worthwhile to note that the use of the secondary key/slot adds another security feature to the connector system—essentially another keying mechanism. This additional keying feature increases the number of permutations within a given connector system. That is, rather than maintaining the same secondary key and slot location for all connectors within a system, it can be moved to form different classes within the same family

Preferably, the keying elements (primary and secondary) are positioned such that not mating pairs “stub” at about the same axial position relative to one another regardless of whether the connectors are interfering because they are different types of secure connectors or whether they are interfering because they are secure/non-secure connectors. This way, the user becomes accustomed to the point at which non-mating connector components interfere, thereby reducing the risk of the user forcing non-mating components together.

To provide a simple and readily apparent indication to the user of which plugs mate with which receptacles, it is preferable to mark mating pairs with indicia or color to indicate their compatibility. In a preferred embodiment, the components of a mating pair are a similar color different from all others used in the connector system.

The system described allows for a series of mutually-exclusive connectors to be used in a manner which provides physical security to a network system. In light of the often highly sensitive data stored on many of the networks in use today, this is a highly desirable feature. The present invention is an effective way to segregate separate networks and assure that the proper users are connecting to the desired network. Additionally, the present invention may be employed in the manufacture of devices in which fibers or wires need to be connected in particular arrangements. More specifically, the discriminating connectors of the present invention can be engineered into a system such that, during manufacturing, the correct connection of the fibers/wires is ensured by the mating pairs and their ability to prevent all other “incorrect” connections. Applications requiring particular routing of fibers or wires include, for example, routers, backplane assemblies, and even component devices such as multiplexers/demultiplexers.

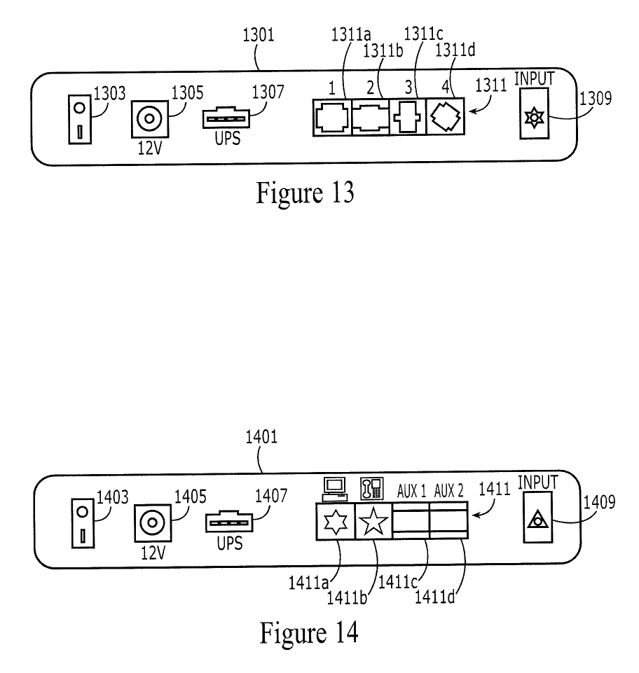

FIG. 13 is a plan view of a back panel of an Optical Network Terminal (ONT) 1301 in accordance with the principles of the present invention. It includes a power switch 1303, a power input terminal 1305, an uninterrupted power supply terminal 1307, an input terminal 1309, and four output terminals 1311a-1311d. The input terminal 1309 is substantially an LC type receptacle, but has a special physical feature, represented schematically by the star shape 1313 of the receptacle, so that it can be mated only to a cable bearing a complementary special physical feature. In this manner, it can be coupled a network access point, such as a wall outlet, only using a cable having a connector that has a complementary special physical feature. In an enterprise that has different network access points with accessibility to different networks, then there may be provided a set of a plurality of different pairs of connectors and opposing connectors (e.g., a set of receptacles and a matching set of plugs) bearing special physical features and complementary special physical features, respectively, for connecting ONT input terminals to cables for coupling to network access points. The set of special physical feature and the set of complementary special physical features should be adapted to allow unique coupling of each special physical feature to one and only one of the complementary special physical features. It also should prevent coupling of a connector with a special physical feature to an opposing connector having no special physical feature.

The other end of that cable couples to the network access point, such as a wall outlet, and may bear a standard connector without a special physical feature for mating with a standard connector in the wall outlet. However, preferably, the other end of that cable bears another connector having a special physical feature so that it may be coupled only to a wall outlet having a connector bearing the matching complementary special physical feature.

The ONT 1301 also has four output terminals comprising receptacle connectors 1311a-1311d for coupling four separate computers to four different subsets of networks available through the ONT and the network access point to which the ONT is coupled. In this exemplary embodiment, the ONT 1301 is programmed to provide connectivity through each of its output terminals 1311a, 1311b, 1311c, and 1311d to a different one of four different networks. Each of the output receptacle connectors 1311a, 1311b, 1311c, and 1311d has a special physical feature that is different and unique from each other and which prevents any plug connector from mating to it other than a plug connector having the complementarily matching special physical feature. The first set of different special physical features available for incorporation into the ONT output connectors is selected so that each different special physical feature allows the output connector to be coupled only to one of a second set of complementary connectors (e.g., a plug connector) having a second set of complementarily matching special physical features and to physically prevent it from being coupled to any other of the second set of complementary connectors having any one of the second set of complementary special physical features or to a complementary connector having a universal physical feature.

For added security, it is preferable that the set of special physical features used for providing keyed connectivity to the output terminals 1311 is mutually exclusive of the special physical feature (or set of special physical features) used in connection with the network access points and/or ONT input terminals 1309.

Preferably, each of the output receptacle connectors 1311a-1311d is a different color corresponding to each different special physical feature in order to render them more easily visually distinguishable from each other. Further, the complementary plug connectors adapted to mate to each of the different receptacle connectors 1311a-1311d also preferably are color coded with the same color as the receptacle connector 1311a-1311d to which it is may be coupled.

FIG. 14 shows a back panel of an alternative Optical Network Terminal 1401 in accordance with the principles of the present invention. This ONT may connect to the same network access point as ONT 1301 of FIG. 13, but is adapted to provide connectivity to only three of the networks, including an unsecured network not supported by ONT 1301 of FIG. 13. Specifically, ONT 1401 provides connectivity to two secured networks and one unsecured network as described in more detail below. ONT 1401 includes a power switch 1403, a power input terminal 1405, an uninterrupted power supply terminal 1407, an input terminal 1409, and four output terminals 1411a-1411d. ONT 1401 is substantially similar to the ONT 1301 of FIG. 13, except for its programming and the output terminals 1411a-1411d. More specifically, ONT 1411 is programmed to provide connectivity to a first, secured network through output connectors 1411, provide connectivity to a second, secured network through output terminal 1411b, and to provide connectivity to a third, unsecured network through both output terminals 1411c and 1411d. Thus, output connectors 1411a and 1411b each has a different special physical feature that prevents any complementary connector from mating to it other than a complementary connector having the complementarily matching special physical feature. However, output terminals 1411c and 1411d provide access to an unsecured network. Therefore, they bear unkeyed connectors (i.e., having no special physical feature) so that computers can be coupled to these output connectors using conventional cables bearing conventional connectors of the form factor used for output connectors in this network.

Having thus described particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. An Optical Network Terminal (ONT) adapted to provide restricted access to a plurality of networks, the ONT comprising:
an input terminal for coupling the ONT to a plurality of networks and at least first and second output terminals, each output terminal for coupling a device to one or more of the networks through the ONT, wherein the first output terminal provides connectivity to a first subset of the networks and the second output terminal provides connectivity to a second subset of the networks, the second subset being different than the first subset;
a first connector in the first output terminal of the ONT having a first special physical feature that prevents the first connector from being coupled to an opposing connector unless that opposing connector has a first complementary special physical feature complementary to the first special physical feature; and
a second connector in the second output terminal of the ONT having a second special physical feature that prevents the second connector from being coupled to an opposing connector unless that opposing connector has a second complementary special physical feature complementarily matching the second special physical feature;
wherein the first special physical feature of the first connector prevents coupling of the first connector to an opposing connector having the second complementary special physical feature or an opposing connector lacking a special physical feature.

2. The ONT of claim 1 further comprising:
additional output terminals that provide connectivity to additional subsets of the networks, respectively, each additional output terminal comprising an additional connector having an additional special physical feature that prevents the additional connector from being coupled to any opposing connector unless the opposing connector has an additional complementary special physical feature complementarily matching the additional special feature;
wherein each of the additional subsets of networks is unique relative to each other subset of networks and each additional special physical feature is unique relative to the other special physical features; and
wherein each additional special physical feature prevents coupling of a connector having that additional special physical feature to an opposing connector having a complementary special physical feature other than the complementarily matching complementary special physical feature or to an opposing connector lacking a complementary special physical feature.

3. The ONT of claim 1 wherein the input terminal comprises a third keyed connector having a third special physical feature that prevents it from being coupled to an opposing connector unless that opposing connector has a complementary special physical feature complementarily matching to the third special physical feature;
wherein the third special physical feature of the third keyed connector prevents coupling of the third keyed connector to an opposing connector having a complementary special physical feature other than the complementarily matching complementary special physical feature or an opposing connector lacking a complementary special physical feature.

4. The ONT of claim 3 wherein the first and second connectors are electrical connectors and the third connector is an optical connector.

5. The ONT of claim 1 wherein the connectors of the output terminals are receptacle connectors and the opposing connectors are plug connectors.

6. The ONT of claim 3 wherein the connector of the input terminal and the connectors of the output terminals are receptacle connectors and the opposing connectors are plug connectors.

7. A network comprising:
a network infrastructure comprising a network cable transporting network data for a plurality of networks;
a plurality of different types of Optical Network Terminals (ONTs), each different type of ONT having an input connector for coupling the ONT to the network cable and a plurality of output connectors, each output connector for coupling a device to one or more of the networks through the ONT, wherein each different ONT is configured to provide connectivity to the networks via its plurality of output connectors in different permutations of subsets of the networks at particular output connectors;
wherein the input connector of each different type of ONT comprises a different one of a first set of input connectors, each said different one of said first set of input connectors having a one of a first set of special physical features; and
a plurality of different ONT cables for coupling the input connectors of the ONTs to the network cable, each said different ONT cable having a first end and a second end, the first end bearing a different one of a second set of opposing connectors for coupling the ONT cable to an input connector of an ONT, wherein each one of said second set of opposing connectors has a different one of a second set of special physical features
wherein the first and second sets of special physical features are adapted such that each one of the first set of input connectors can be coupled to only one of the second set of opposing connectors and prevents that one of the first set of input connector from being coupled to any other one of the second set of opposing connectors.

8. The network of claim 7 wherein each one of the first set of special physical features prevents the corresponding input connector from being coupled to an opposing connector unless that opposing connector has a corresponding one of the second set of special physical features that complementarily matches the one of the first special physical features and each one of the second set of special physical features prevents the corresponding opposing connector from being coupled to any one of the first set of input connectors of the ONT unless that input connector has a corresponding one of the first special physical feature that complementarily matches the one of the second special physical features.

9. The network of claim 8:
wherein the network cable comprises a plurality of different types of network cable connectors for permitting coupling of the second ends of the ONT cables to the network cable, each said different type of network cable connector having a one of a third set of special physical features;
wherein the second ends of the ONT cables bear one of a fourth set of opposing connectors for coupling the ONT cable to the network cable via coupling to a one of the third set of network cable connectors, wherein each one of the fourth set of opposing connectors has a different one of a fourth set of special physical features;
wherein the third and fourth sets of special physical features are adapted such that each one of the third set of keyed network connectors can be coupled to only one of the fourth set of opposing connectors bearing the corresponding fourth special physical feature and prevents that one of the third set of network cable connectors from being coupled to any other one of the fourth set of opposing connectors.

10. The network of claim 9 wherein each one of the third set of special physical features prevents the network cable from being coupled to an opposing connector unless that opposing connector has a corresponding one of the fourth set of special physical features that complementarily matches the particular one of the third set of special physical features of that network cable connector and each one of the fourth set of special physical features prevents the opposing connector from being coupled to any one of the third set of network cable connectors unless that network cable connector has the corresponding one of the third set of special physical features.

11. The network of claim 10 wherein the first set of special physical features and the third set of special physical features are the same and the second set of special physical features and the fourth set of special physical features are the same.

12. The network of claim 7:
wherein each of the plurality of output connectors of an ONT is a different one of a fifth set of output connectors, each said different one of said fifth set of output connectors having a one of a fifth set of special physical features; and
a plurality of different device cables for coupling devices to the network cable through the ONTs, each said different device cable having a first end and a second end, the first end bearing a different one of a sixth set of opposing connectors for coupling the first end of the device cable to an output connector of an ONT, wherein each one of the sixth set of opposing connectors has a different one of a sixth set of special physical features;
wherein the fifth and sixth sets of special physical features are adapted such that each one of the fifth set of output connectors can be coupled to only one of the sixth set of opposing connectors bearing the corresponding one of the sixth set of special physical feature and prevents that one of the fifth set of output connector from being coupled to any other one of the sixth set of opposing connectors.

13. The network of claim 12 wherein each one of the fifth set of special physical features prevents the corresponding output connector from being coupled to an opposing connector unless that opposing connector has a corresponding one of the sixth set of special physical features that complementarily matches the particular one of the fifth set of special physical features, and each one of the sixth set of special physical features prevents the corresponding opposing connector from being coupled to any one of the fifth set of output connectors of the ONT unless that output connector has the corresponding one of the fifth set of special physical features that complementarily matches the particular one of the sixth set of special physical features.

14. The network of claim 13 wherein the fifth and sixth sets of special physical features are mutually exclusive of the first and second sets of special physical features such that the none of the connectors of the first and second sets of connectors can be coupled to any of the connectors of the fifth and sixth sets of connectors and none of the connectors of the fifth and sixth sets of connectors can be coupled to any of the connectors of the first and second sets of connectors.

15. The network of claim 7 wherein the network is a passive optical network (PON) and the network cable is an optical cable and the first set of input connectors of the ONT and the second set of opposing connectors are optical connectors.

16. The network of claim 15 wherein the first set of input connectors of the ONT and the second set of opposing connectors are LC optical connectors.

17. The network of claim 7 wherein the device cable is an electrical cable and the fifth set of output connectors of the ONT and the sixth set of opposing connectors are electrical connectors.

18. The network of claim 17 wherein the fifth set of output connectors of the ONT and the sixth set of opposing connectors are RJ-45 connectors.

19. The network of claim 12 wherein the first set of input connectors and the fifth set of output connectors are receptacle connectors and the second set of opposing connectors and the sixth set of opposing connectors are plug connectors.

20. The network of claim 7 wherein the first set of special physical features comprise keys and the second set of special physical features comprise slots.
